(19) United States
(12) Patent Application Publication
(10) Pub. No.: US 2009/0025468 A1
(43) Pub. Date: Jan. 29, 2009

(54) Piezoelectric Combustion Chamber Pressure Sensor Having a Pressure Transmission Pin

(76) Inventors: Gottfried Flik, Leonberg (DE); Oliver Stoll, Reutlingen (DE); Juergen Krueger, Remseck-Aldingen (DE); Sven Zinober, Gundelfingen (DE)

Correspondence Address: KENYON & KENYON LLP, ONE BROADWAY, NEW YORK, NY, 10004, US

(21) Appl. No.: 11/663,323

(22) PCT Filed: Aug. 19, 2005
(86) PCT No.: PCT/EP05/54097

§ 371 Date: Feb. 20, 2008

(30) Foreign Application Priority Data
Sep. 29, 2004 (DE) 102004047143.6

(51) Int. Cl. G01L 23/10

(52) U.S. Cl. 73/114.18

(57) ABSTRACT

A sensor made of a single-crystal, piezoelectric material for measuring the pressure in a combustion chamber of an internal combustion engine, having a pressure transmission pin, a displaceably mounted heating pin protruding into the combustion chamber being provided as the pressure transmission pin, and the sensor being friction-locked with the heating pin. The sensor is preferably situated between the heating pin and a rigid thrust bearing. The single-crystal piezoelectric material of the sensor is preferably made of lithium niobate (LiNbO₃). A particularly high sensitivity of the sensor is achieved by the use of a Z-cut or Y-cut piezoelectric material.

### FIELD OF THE INVENTION

The present invention relates to a piezoelectric sensor for measuring the pressure in a combustion chamber of an internal combustion engine, having a pressure transmission pin.

### BACKGROUND INFORMATION

For different applications it is desirable to detect the pressure in a combustion chamber using a suitable sensor. A sensor made of piezoelectric material for determining pressure in a combustion chamber of an internal combustion engine is described, for example, in German Patent No. DE 692 09 132. As is generally known, electric charges are generated in a piezoelectric material to which a mechanical pressure is applied. These charges produce an electric voltage in the piezoelectric material, which may be picked up and measured. Since the sensor is damaged when the piezoelectric material is directly exposed to the high temperatures of the combustion chamber, the pressure in the combustion chamber is first applied to a pressure-receiving component which is directly exposed to the combustion chamber. The pressure-receiving component then relays the pressure ultimately to the piezoelectric material of the sensor. According to the teaching of the above-mentioned document, the pressure is first applied to a diaphragm on the cylinder head of the engine, and then transmitted to the piezoelectric material via a pressure transmission pin connected to the diaphragm.

However, the device described in the related art has certain disadvantages. First, diaphragms as pressure receivers in a combustion chamber pose a problem, because the service life of such a component is limited, for example, due to contamination, by soot particles in particular. The mechanical stability of a diaphragm is also considered critical compared to other components. Furthermore, in the above-described device the pressure sensor is provided as an individual component on the cylinder head of the engine. However, the space available for installation on the cylinder head is very limited. Today's engines typically have a plurality of intake and exhaust valves for each combustion chamber; furthermore, in direct injection technology, in addition to a fuel injector for direct injection of fuel into the combustion chamber of the engine, engines having an externally supplied ignition also require a spark plug for igniting the fuel. Engines having auto-ignition require a sheathed-element glow plug. However, difficulties are encountered when placing the diaphragm having the pressure transmission pin directly on the combustion chamber.

### SUMMARY OF THE INVENTION

The piezoelectric sensor SE according to the present invention having a pressure transmission pin has the advantage over the related art that it makes it possible to integrate the sensor into already existing components of the engine, thus providing a space-saving approach. In particular, the diaphragm known from the related art as a pressure-receiving component is no longer needed, which alleviates the contamination problem. Furthermore, the piezoelectric material of the sensor is advantageously separated from mechanical tightening torques and thermally induced mechanical stresses on the cylinder head, thus minimizing erroneous pressure measurements.

### BRIEF DESCRIPTION OF THE DRAWINGS

FIG. 1 shows a piezoelectric sensor, integrated into a sheathed-element glow plug, having a thrust bearing.

FIGS. 2a through 2c show one embodiment each of the sensor in sectional and top views.

FIG. 3 shows a quartz crystal having crystallographic axes X, Y, and Z in perspective view.

FIG. 4 shows a hexagonal quartz crystal in cross section.

FIG. 5 shows an X cut piezoelectric component with a cut angle θ.

FIG. 6 shows the linear dependence of the sensitivity of the Z cut on the temperature.

FIG. 7a shows a Z cut piezoelectric material 1 in perspective view in the case of a force applied obliquely.

FIGS. 7b and 7c show vector representations for clarifying angles α and β.

FIGS. 8a and 8b show the sensitivity of the Z cut piezoelectric material as a function of angles α and β.

FIGS. 9a and 9b show the sensitivity of the Y cut piezoelectric material as a function of angles α and β.

### DETAILED DESCRIPTION

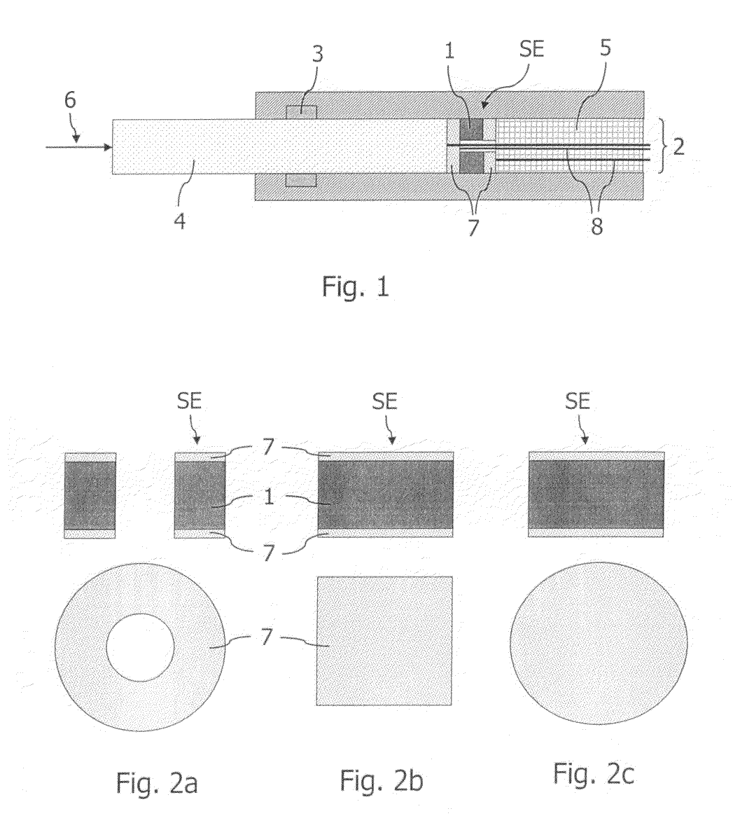

FIG. 1 shows an exemplary embodiment of sensor SE according to the present invention, made of a piezoelectric material 1 and integrated into a sheathed element glow plug. Sensor SE is situated in a channel 2 leading to the combustion chamber of an internal combustion engine. It is, however, not directly exposed to pressure 6 of the combustion chamber, but is friction-locked with a heating pin 4. Heating pin 4 is partially situated in channel 2; however, one of its ends protrudes into the combustion chamber and is displaceably, in particular axially displaceably mounted. Typically heating pin 4 is mounted in a seal 3, in particular an O-ring, graphite ring, or a metal bead. Sensor SE itself is situated on the side of heating pin 4 facing away from the combustion chamber. Furthermore, a rigid thrust bearing 5 is mounted downstream from sensor SE in the opposite direction from the combustion chamber.

If a pressure 6 is applied to heating pin 4, axially displaceably mounted heating pin 4 relays the pressure 6 to piezoelectric material 1, which is mechanically deformed due to downstream rigid thrust bearing 5. The value of pressure 6 in combustion chamber 3 may be derived by measuring the voltage across piezoelectric material 1. To pick up the voltage, sensor SE made of piezoelectric material 1 is metal plated on two sides, as FIGS. 2a through 2c show, via a chromium-gold (CrAu) layer, in particular alloy, to form electrodes 7. As FIG. 1 shows, electrodes 7 are situated in such a way that they are perpendicular to the action of pressure and are contacted by electric lines 8 directly or indirectly via metal disks (not shown in the figures). Possible external shapes of sensor SE include preferably that of a ring (FIG. 2a), in addition to a parallelepiped (FIG. 2b) or a solid disk (FIG. 2c), since electric lines 8 may then be passed through the open center of the ring. The electric line for the glow current of the glow plug may also be passed through the open center of the ring.

Due to the above-described arrangement of sensor SE, sensor SE is integrated into a sheathed element glow plug or into an existing channel 2 leading to the combustion chamber. Neither a dedicated channel 2 nor a dedicated pressure transmission pin is needed for sensor SE, but the two are rather advantageously used for two different purposes. Neither is a diaphragm needed as a pressure-receiving component. An additional advantage results from the fact that forces such as the tightening torque acting on the glow plug housing when it is screwed into the cylinder head have almost no effect on sensor SE.

The overall performance of sensor SE may be further improved by an appropriate choice of material and by defined crystal cuts. Mainly quartz or piezoelectric ceramic is used as piezoelectric material 1 in a piezoelectric sensor SE. Both options have, however, certain relative advantages and disadvantages. On the one hand, quartz, as the single-crystal form of silicon dioxide SiO₂, exhibits no aging and is thermally stable up to a relatively high temperature of 573° C. At an even higher temperature, quartz changes from its α form to the β form, when it loses its piezoelectric property. On the other hand, quartz has a low sensitivity of only 2.3 pC/N, so that normally the charge of two piezoelectric elements connected in parallel is used. This requires a high degree of complexity and thus high costs for construction and wiring. In contrast, piezoelectric ceramics have high sensitivity; therefore, no complicated construction involving a plurality of piezoelectric elements is needed. However, the sensitivity of piezoelectric ceramics disadvantageously changes over their service life. The change is caused by depolarization in piezoelectric ceramics and strongly limits the application possibilities of the material. Depolarization is accelerated by the effect of relatively great forces, so that these materials are operated only with small forces. In addition, high forces result in non-linear and hysteretic charge-force characteristics. This problem is aggravated at temperatures over 50% of the Curie temperature.

To circumvent the disadvantages of the two materials, sensor SE according to the present invention is advantageously made of the single-crystal, piezoelectric material lithium niobate (LiNbO₃). The Curie temperature of this material is above 1200° C. At the same time, high sensitivity and a low temperature coefficient are achieved via selected cuts from the crystal.

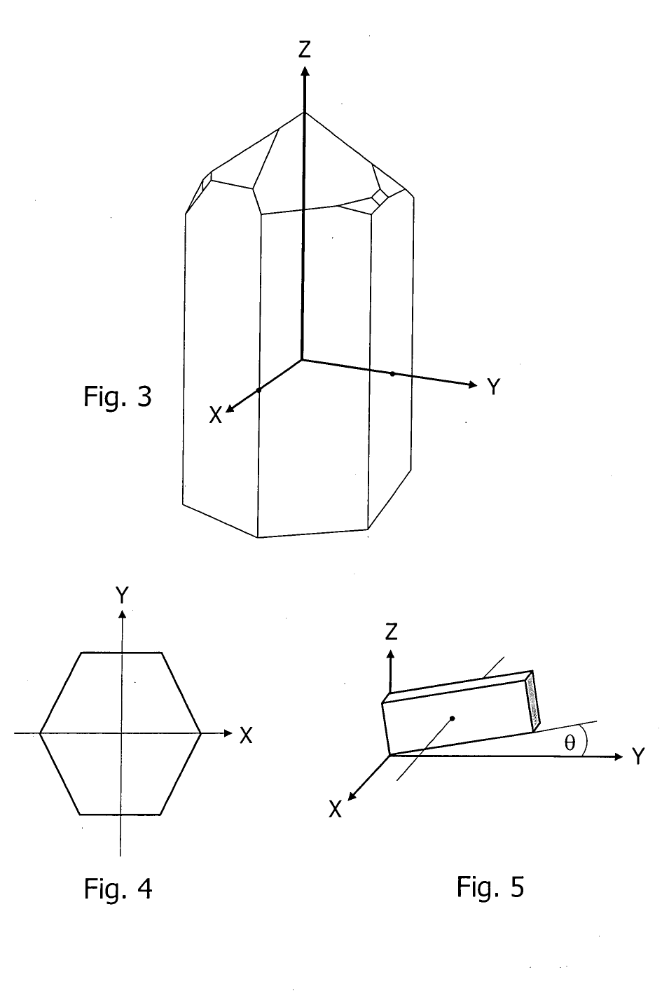

To define the different cuts from the crystal, FIG. 3 shows a quartz crystal having crystallographic axes X, Y, and Z in perspective view. Based on the configuration of a natural quartz crystal having a hexagonal cross section and on the usual crystallographic definition of the orthogonal X, Y, and Z axes, we define the imaginary axis passing through the crystal's tip as the Z axis. An axis perpendicular thereto and passing through one corner of the hexagonal prism is defined as the X axis. The Y axis is in turn perpendicular to the two other axes and thus passes through one face of the crystal. FIG. 4 shows the hexagonal crystal in cross section, i.e., the X-Y plane is visible in top view. As mentioned previously, the piezoelectric component may be cut from the crystal under an optimum axial cut and/or cut angle θ for achieving certain properties such as a minimum temperature coefficient. The cuts are identified by the crystallographic axis normal to the main face. The main face is the face of the component at which the pressure, i.e., the force applied to the component, is introduced later. Thus, for example, FIG. 5 shows an X cut piezoelectric component, since the component has been cut from the crystal in such a way that the X axis of the crystal is normal to the main face of the component. At the same time, the component forms a cut angle θ with the Y axis. The above nomenclature of crystallographic axes X, Y, and Z also apply in a similar manner to LiNbO₃ crystals; it is to be taken into account that the cross section of the LiNbO₃ crystal has the basic face of a ditrigonal prism. The exact geometric shape with the axis designations can be found in the specialized literature.

LiNbO₃ components having Z or Y cuts are preferably used, i.e., the Z or Y axis of the crystal is perpendicular to the main face of the component or, in other words, to the plane of introduction of the force.

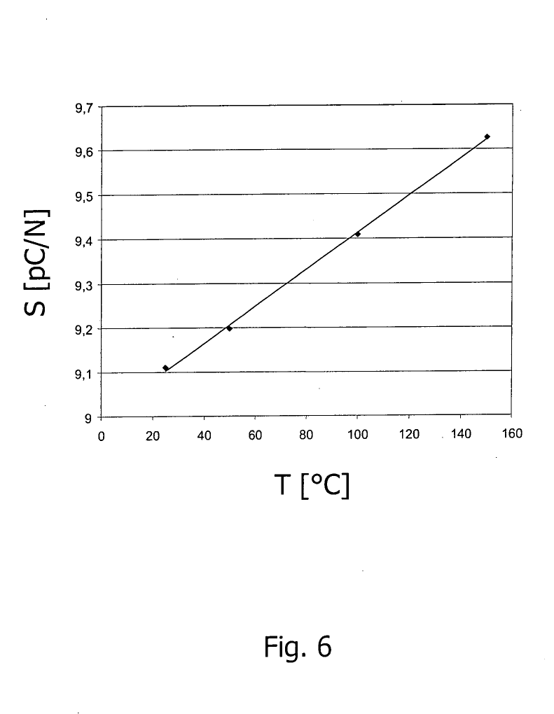

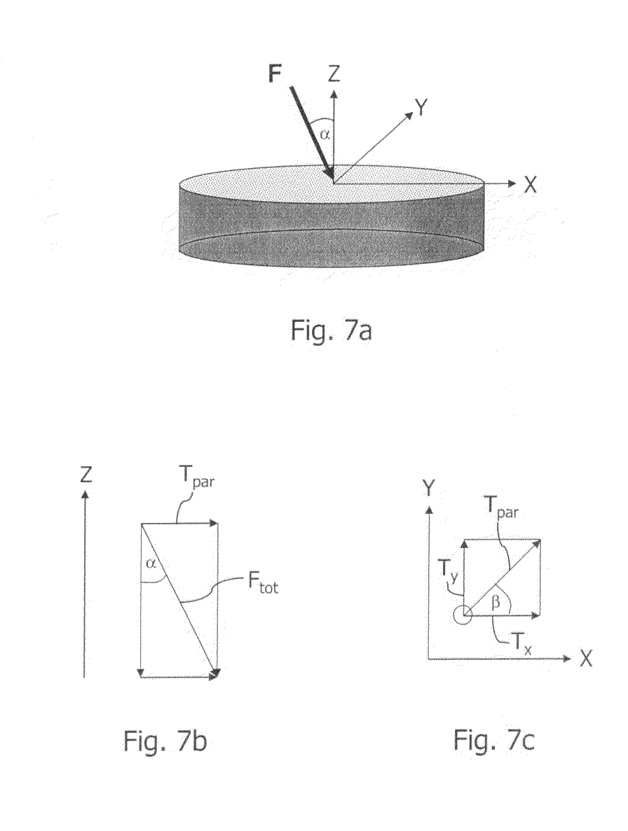

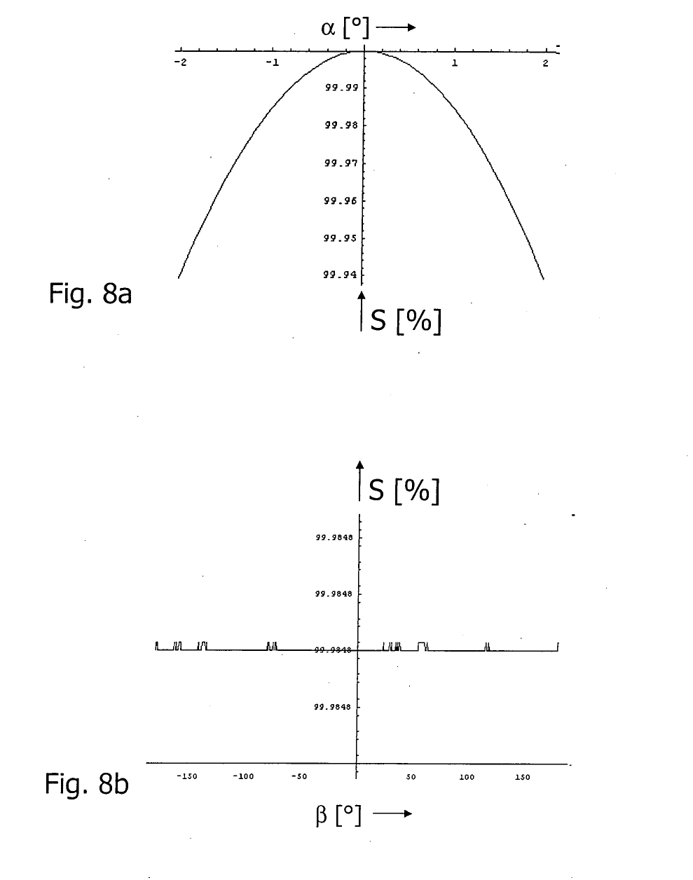

First, the sensitivity of a LiNbO₃ component having a Z cut is advantageously greater than that of a quartz component by a factor of approximately three. The temperature coefficient is approximately 480 ppm/K, somewhat more than that of quartz; however, as FIG. 6 shows, sensitivity S changes linearly with temperature T and thus may be easily compensated. In addition, the Z cut offers the advantage of a low transverse sensitivity to obliquely introduced forces. For greater clarity, FIG. 7a shows the Z cut piezoelectric component in perspective view with the crystallographic X, Y, and Z axes shown. According to the above definition, the Z axis here, in a Z-cut component, is perpendicular to the plane of introduction of force. If a force F is not applied perpendicularly to this face, but at an angle α not equal to zero with respect to the Z axis, so the total force Fₜₒₜ may be vectorially decomposed into a tangential component Tₚₐᵣ, which is parallel to the main face or X-Y plane of the component, and a Z component F_{z}, which is parallel to the Z axis. The vector decomposition of the total force Fₜₒₜ into components Tₚₐᵣ and F_{z} is shown in FIG. 7b, where vectors Fₜₒₜ and F_{z}, form an angle α. Tangential component Tₚₐᵣ may in turn be decomposed into further components Tₓ and T_{y}, which are parallel to the X and Y axes, respectively. As FIG. 7c shows, components Tₚₐᵣ and Tₓ form an angle β. Furthermore, FIGS. 8a and 8b show the percentage change in sensitivity S of the Z-cut piezoelectric component as a function of angles α and β. Sensitivity S drops only slightly.

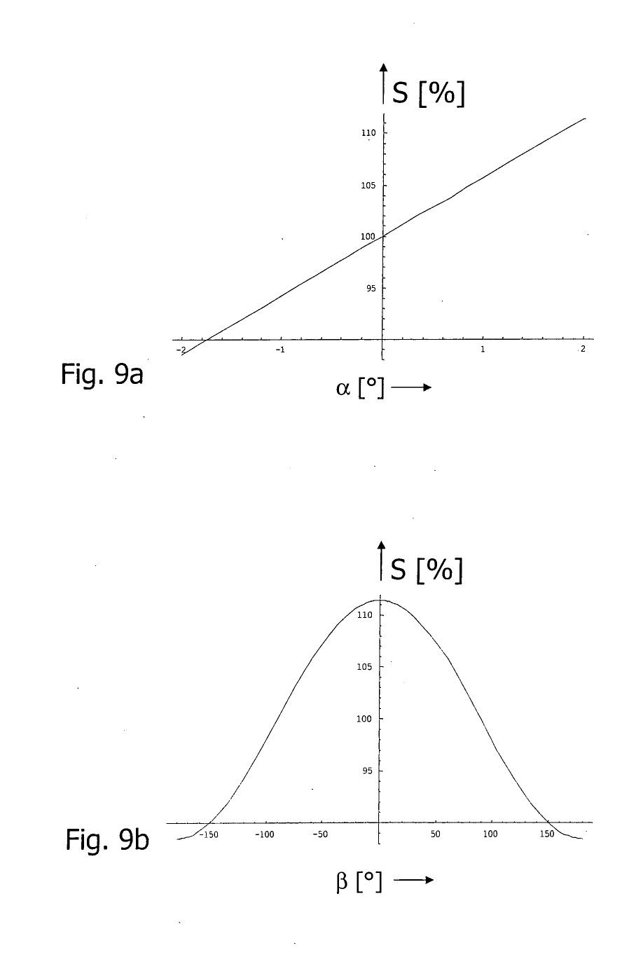

The Y cut provides a significantly higher sensitivity S of 20 pC/N compared with the previously mentioned values, while having a low temperature coefficient of 240 ppm/K. However, the sensitivity strongly depends on angles α and β of introduction of the force (FIGS. 9a and 9b). Oblique force introduction surfaces or non-parallelism of the faces of the piezoelectric component result in large angles α and β, and thus affect the sensitivity. The high sensitivity S may, however, be used if the component is mounted with careful and correct orientation in channel 2. A certain amount of sensitivity variation may also be compensated and therefore tolerated.

1-9. (canceled)

10. A sensor composed of a single-crystal, piezoelectric material for measuring a pressure in a combustion chamber of an internal combustion engine, comprising:
a pressure transmission pin embodied as a displaceably mounted heating pin protruding into the combustion chamber, the sensor being friction-locked with the heating pin.

11. The sensor according to claim 10, wherein the sensor is situated on a side of the heating pin facing away from the combustion chamber.

12. The sensor according to claim 10, further comprising a rigid thrust bearing mounted downstream from the sensor in an opposite direction of the combustion chamber.

13. The sensor according to claim 10, further comprising a seal, the heating pin being mounted displaceably in the seal, the seal being one of an O-ring, a graphite ring, and a metal bead.

14. The sensor according to claim 10, wherein the single-crystal piezoelectric material of the sensor is lithium niobate (LiNbO₃).

15. The sensor according to claim 10, wherein the single-crystal piezoelectric material of the sensor has one of a Z cut and a Y cut.

16. The sensor according to claim 10, wherein the single-crystal piezoelectric material is metal plated on two sides, using a chromium-gold (CrAu) layer for forming electrodes.

17. The sensor according to claim 10, wherein the sensor has an external shape of one of a ring, a parallelepiped, and a solid disk.

18. The sensor according to claim 17, wherein electric lines for at least one of the sensor and the heating pin pass through an open center of the ring.
